(19) United States
(12) Patent Application Publication
(10) Pub. No.: US 2020/0378158 A1
(43) Pub. Date: Dec. 3, 2020

(54) T-Shaped Lever Gate Latch Pull System and Kit

(71) Applicant: Karen H. Weber, Woodinville, WA (US)

(72) Inventor: Karen H. Weber, Woodinville, WA (US)

(21) Appl. No.: 16/427,532

(22) Filed: May 31, 2019

(51) Int. Cl. E05B 65/00; E05B 53/00

(52) U.S. Cl. CPC E05B 65/0007; E05Y 2900/40; E05B 53/00

(57) ABSTRACT

A lever gate latch pull system with a pivoting T-shaped lever has two aligned first and second arms affixed to a swinging base foaming a T with a pivot hole proximate the junction of the aligned first and second arms and the swinging base. The T-shaped lever is pivotally affixed to a fence post to pivot the arms up and down as the swinging base correspondingly moves in a side to side upward arc. Affixed to the end of the swinging base is a weighted chain extending to and secured via a fastener to the free end portion of the pivotal latch lever of the gate latch in the resting position. The weighted chain provides pressure on the pivotal latch lever to stay in the latched position until lifted by the T-shaped lever. In operation, when the T-shaped lever handle first or second arms are positioned just beneath the top of the fence and depressed, they pivot the swinging base in an upward arc to pull the chain up to unlatch the gate latch to open the gate from either side.

### BACKGROUND OF THE INVENTION

This invention pertains to gate latch pull systems. More particularly it relates to a T-shaped lever gate latch pull system and kit of simple construction readily mounted on a gate post, fence or structure above the latch.

Statement of the Art. There are a number of latching systems, Casey, U.S. Pat. No. 5,655,801 issued Aug. 12, 1997 discloses a gate latch with a bent lever arm passing through a gate with linkage associated with the gate latch for opening it from the outside.

Glover, U.S. Pat. No. 9,297,187 issued Mar. 29, 2016 is another gate latch release mechanism with a cylindrical tubular guide positioned in a hole through a gate with a flexible line affixed to the latch handle for opening the gate latch from outside. This flexible line can kink or bind when drawn through the tubular guide in the fence post.

Van Wieb, U.S. Pat. No. 5,358,292 issued Oct. 25, 1994 is a gate latch pull system secured to a stationary gate post pulled from outside the gate secured to the gate latch to open it from the outside. It also employs a flexible cable with coiled spring, which can kink or bind when drawn through a bore hole in the gate, when pulled from the outside.

Bieganski, U.S. Pat. No. 5,078,438 issued Jan. 7, 1992 is another gate closure latch using a pull ring string passing through the gate tied to the gate assembly for opening it from the outside. It is secured to the ends of a pair of hand grips.

Thomas, U.S. Pat. No. 4,938,508 issued Jul. 3, 1990 is a gate latch with a pull mechanism to allow the gate latch to be unlatched when pulled. It incorporates a spring biased plunger preventing the pivotal latch member from being unlatched by the wind.

Cited for general interest are:

Wepf, U.S. Pat. No. 9,528,306 issued Dec. 27, 2016 is a locking latch for yard doors with a lock base and lock cover openable/closable in a clamshell mode.

Nesseth, U.S. Publication No. 2006/0038416 published Feb. 23, 2006 is a ranch gate assembly for swinging latch gates operable by a horse.

Eblen, U.S. Pat. No. 3,828,475 issued Aug. 13, 1974 is another gate opener for a tractor driven against the gate, which causes the gate to swing open for driving there through. Once the tractor has disengaged, the gate closes via a spring system.

As discussed in Van Wiebe, the present invention is directed to a conventional form of gate latch employed in connection with a stationary gate post amounted adjacent the free edge of a hinged gate. The gate is typically secured to an additional stationary fence post be hinges. A latch bar mounting plate is secured to the gate via conventional fasteners. The latch bar typically includes a right angle bend portion such that the latch bar is disposed in alignment for engagement in a latch bracket secured to the stationary gate post. Alternatively, the bracket may be secured to the gate and the latch bar mounted on the post without altering the function of the components.

The pivotal latch lever includes a recess which partially surrounds the latch bar in the latch position as shown in FIG. 1 prior art. An outermost free end portion of the pivotal latch lever is provided with an aperture through which a string or cord extends. A first end of the string or cord is received through a staple driven into the top end face of the gate post. The first end of the string is secured by a knot or loop to an enlarged ring. A second opposite end of the string or cord is secured by a loop or knot fastener to a second enlarged ring. Thus it is contemplated by pulling on one or both of the rings that the pivotal latch lever may be moved to an unlatch position us a user position on the opposite side of the gate. As this remote latch actuating mechanism does not provide constant downward pressure on the latch lever, it doesn't stop the latch bar from bouncing out when the gate is closed or slammed. Thus upon release of the rings only gravity causes the pivotal latch lever to move to the latched position. There is thus a substantial chance that due to frictional forced in the pivotal mounting of the latch lever or friction of the string and the staple or bore, or the opposing counterweight forced exerted by the rings that the pivotal latch lever will not move to a fully latched position.

There thus remains a need for a simple lever gate latch pull system and kit of straight forward construction readily mounted on a gate post, fence or structure above the latch, which insures that the latch lever prevents the latch bar from bouncing out. The apparatus described below provides such an invention.

### SUMMARY OF THE INVENTION

The present invention comprises: a lever gate latch pull system with a pivoting T-shaped lever having swinging base with an attachment end having two aligned first and second arms affixed to the swinging base forming a T with a pivot hole proximate the junction of the aligned first and second arms to form a T-shaped lever pivotally affixed to a fence post to pivot the swinging base in an up and down arc as the arms pivot up and down. Affixed to the end of the swinging base is a weighted chain extending to and secured via a fastener to the free end portion of the pivotal latch lever of the gate latch in a resting position. The weighted chain provides pressure on the pivotal latch lever to stay in the latched position until lifted by the T-shaped lever. In operation, when the lever handle first or second arms are depressed, they pivot the swinging base in an upward arc to pull the chain up to unlatch the gate latch to open the gate.

The T-shaped lever has first and second arms shaped as paddle handles affixed to the swinging base extending outwardly from the pivot hole. The swinging base extends downwardly from the pivot hole so that its swinging end swings in an upward arc with the weighted chain attached to its end. When the T-shaped lever pivot hole is pivotably attached to a fence post via a fastener, such as a wood screw and washer, the lever handles are positioned usually beneath the top of the fence so that it is invisible from the outside, but allows a user to depress it from both sides of the latched gate to raise the chain to unlatch the gate latch; thereby enabling one to unlatch a locked gate without having to go around to unlatch the gate. Alternatively, the T-shaped lever may be mounted where it may be seen.

The invention may be adapted as a kit to modify an existing latched gate to allow it to be opened from either side. The kit comprises a T-shaped lever with aligned first and second arms attached to a downward swinging base end opposite a pivot hole structured to be pivotally affixed to a fence post to pivot the swinging base end up and down in an arc. A weighted chain is included with one end affixed to the swinging base end and having a fastener attached to its other end; structured to secure to the gate latch in a manner to release its keeper; thereby opening the gate latch. The T-shaped lever arms are preferable structured for positioning usually beneath the top of the fence as discussed above, but can be affixed along the top of the fence with the chain pulling at an angle or at varying heights on the post above the latch.

### DESCRIPTION OF THE DRAWINGS

FIG. 1 illustrates a perspective view of the prior art of a conventional gate latch.

FIG. 2 illustrates a perspective view of the T-shaped lever gate latch pull system in locked position.

FIG. 3 illustrates a side view of the lever gate latch pull system of FIG. 1.

FIG. 4 illustrates a perspective view of the T-shaped lever of FIG. 1.

FIG. 5 illustrates an exploded view of the T-shaped lever of FIG. 1 showing how it is mounted on a fence post.

### DESCRIPTION OF THE ILLUSTRATED EMBODIMENTS

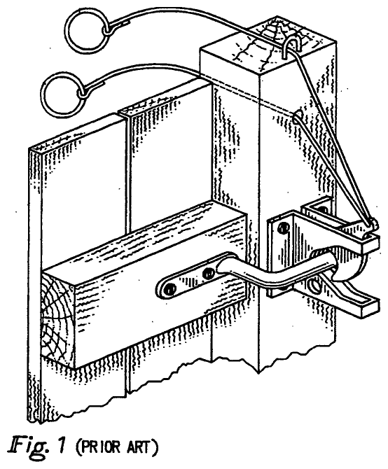

FIG. 1 illustrates a perspective view of the prior art of a conventional gate latch.

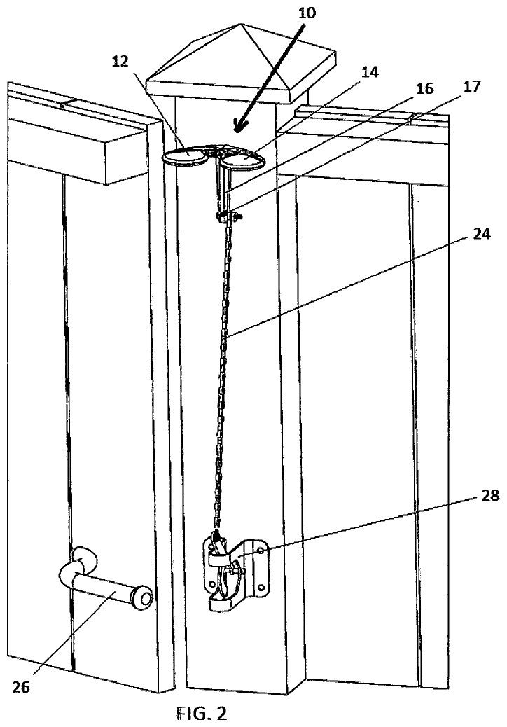

FIG. 2 illustrates a perspective view of the T-shaped lever gate latch pull system of the present invention in locked position, but with the gate keeper 26 free. It comprises a pivoting T-shaped lever 10 with aligned first and second arms 12, 14 shaped as paddle handles. A swinging base 16 is affixed at a midpoint of the aligned first and second arms, 12, 14, forming the T-shaped lever 10. A pivot hole 18 shown in FIG. 5 is positioned proximate the midpoint of the first and second arms 12, 14, when affixed to a fence post via a screw 20 and washer 22, to pivot the aims 12, 14 in an up and down arc via the pivot hole 18. Below the aligned first and second arm 12, 14 is a swinging base 16, which swings its swinging attachment end 17 in an upward arc as the arms 12, 14 lift up and down. Affixed to the swinging attachment end 17 of the swinging base 16 is a weighted chain 24 extending to and secured via a fastener to a gate latch 26 in the resting position. When either lever arm 12, 14 is depressed, the swinging base 16 is lifted in an upward arc to pull the chain 24 up to unlatch the gate latch 28 to release the gate keeper 26 to open the gate.

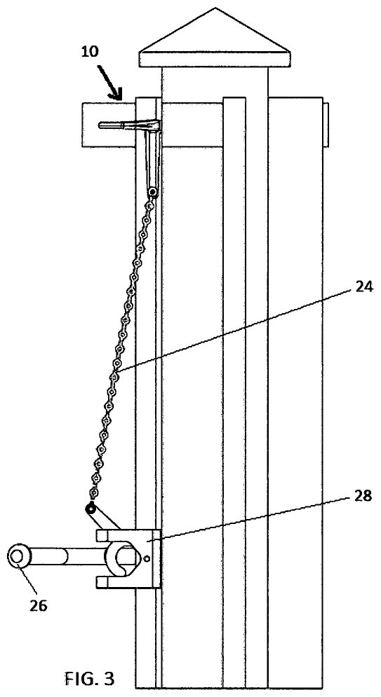

FIG. 3 illustrates a side view of the lever gate latch pull system of FIG. 1.

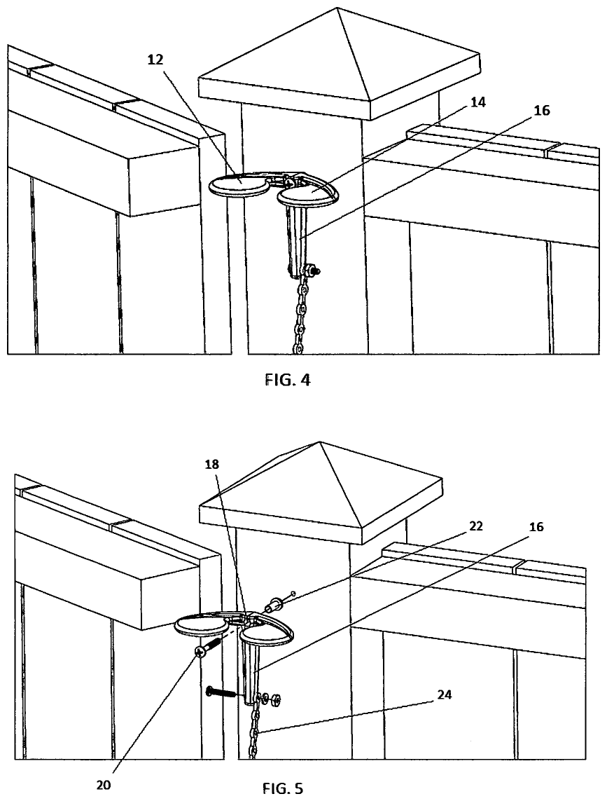

FIG. 4 illustrates a perspective view of the T-shaped lever of FIG. 1.

FIG. 5 illustrates an exploded view of the T-shaped lever of FIG. 4 showing how it is mounted on a fence post.

The T-shaped lever 10 has opposite aligned arms 12, 14. The T-shaped lever 10 pivot hole 18 is pivotably attached to a fence post usually via a wood screw 20 and washer 22. The T-shaped lever arms 12, 14 are positioned usually proximate the top of the fence, allowing a user to depress them from both sides of the latched gate to raise the chain 24 to unlatch the gate latch 28 releasing the keeper 26; thereby enabling one to unlatch a locked gate without having to go around to unlatch the gate.

The dimensions of one example of the T-shaped lever 10 has aligned lever handles 12, 14 of a length 5 inches, and a base 16 of a length of 3 ½ inches. In another example, the base has a length of 1 ½ inches long to prevent hitting the gate upon opening.

Note that the chain 26 is usually installed with some slack to provide the full weight of the chain on the pivotal latch 28 to secure the same in the latched position until pulled up by the upwardly swinging base 16.

Although a chain 24 is shown, other similarly weighted lines, cables, and ropes may be used, provided they are weather resistant. They will all be referred to hereafter as chains 24.

The present invention may be embodied in other specific forms without departing from its structures, methods, or other essential characteristics as broadly described herein and claimed hereinafter. The described embodiments are to be considered in all respects only as illustrative, and not restrictive.

I claim:

1. A lever gate latch pull system for a swinging gate comprising:
(a) a gate latch affixed to a fence post with an openable lifting keeper,
(b) a latch affixed to an edge of a swinging gate edge positioned and aligned with the keeper to latch and unlatch to open or close the swinging gate,
(c) a pivoting T shaped lever having two aligned first and, second arms structured as lever handles joined to a base having a top end and a swinging bottom with an attachment end at the top end forming a T-shaped lever with a center pivot at the top end structured to pivotally affix to fence structure or a post to pivot the swinging bottom in an up and down arc as the arms move up and down, and
(d) a weighted chain with a first chain end affixed to the swinging bottom attachment end and a second chain end affixed to the pivotal latch of a length to hang and provide pressure on the pivotal latch to stay in a latched position until raised up to lift and open the keeper to release the latch as the lever handle is activated to lift the chain to open the gate latch.

2. A lever gate latch pull system according to claim 1, wherein the center pivot is structured as a pivot hole, through which a fastener extends with one end structured to secure to the fence structure or post, and the other end is flanged larger than the pivot hole to prevent the pivoting T shaped lever from removal as the T shaped lever is pivoted up and down.

3. A lever gate latch pull system according to claim 1, wherein the lever handles are positioned just below the top of the fence so that it is invisible from the outside, but allows a user to depress it from both sides of the latched gate to raise the chain to unlatch the gate latch.

4. A lever gate latch pull system kit for a swinging gate having a gate latch affixed to a fence post with an openable lifting keeper, and a latch affixed to an edge of the swinging gate edge positioned and aligned with the keeper to latch and unlatch to open or close the swinging gate, comprising:
a pivoting T shaped lever having:
two aligned first and second arms structured as lever handles joined to a base having a top end and a swinging bottom with an attachment end at the top end forming a T-shaped lever with a center pivot at the top end structured to pivotally affix to fence structure or a post to pivot the swinging bottom in an up and down arc as the arms move up and down, and
a weighted chain with a first chain end affixed to the swinging end and a second chain end with a fastener to affix to the pivotal latch of a length to hang and provide pressure on the keeper to stay in a latched position until raised up to lift and open the keeper to release the latch as the lever handle is activated to lift the chain to open the gate latch,

5. A lever gate latch pull system kit, according to claim 4, wherein the first chain end includes a fastener to affix to the chain to the swinging bottom.
